(19) United States
(12) Patent Application Publication
(10) Pub. No.: US 2002/0042953 A1
(43) Pub. Date: Apr. 18, 2002

(54) Support pillow kit with toy bar

(76) Inventor: Susan H. Matthews Brown, Evergreen, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/802,097

(22) Filed: Mar. 8, 2001

Related U.S. Application Data
(63) Continuation-in-part of application No. 09/679,139, filed on Oct. 3, 2000.

(51) Int. Cl. B68G 5/00; A47C 16/00; A47C 20/02

(52) U.S. Cl. 5/655

(57) ABSTRACT

A play kit comprises a pillow having a pillow body with medial region and a pair of opposing arms that define a generally open well. The pillow further includes a mat that is operably connected to the pillow body. A suspension system is used to suspend one or more objects above the pillow.

### CROSS REFERENCE TO RELATED APPLICATIONS

This application is a continuation in part application of U.S. application Ser. No. 09/679,139, filed Oct. 3, 2000, the complete disclosure of which is herein incorporated by reference.

### BACKGROUND OF THE INVENTION

This invention relates generally to the field of baby products. More specifically, the invention relates to the display of items, such as toys, to a baby or a small child while being supported by a pillow.

Infants and small children often need to be entertained, pacified or simply distracted. Fortunately, this may be done in such a manner so as to improve physical coordination, to help improve motor skills, or to facilitate educational development. One such way to entertain a small child is by lying the child down and permitting the child to play with one or more toys. However, if the child is unable to move around or hold a toy, it is difficult to keep the child entertained without adult supervision.

To present toys to small children, various products have been marketed that suspend toys above the child. For example, Fischer-Price has a Sparkling Symphony™ Gym product where toys are suspended above the ground on a horizontal pole. However, when lying a child on a hard surface, the child can be uncomfortable. Further, the child may roll around or move along the floor such that the suspended toys become inaccessible to the child.

Hence, this invention is related to the presentation of items, such as toys, to small children. This is done in a comfortable environment while also appropriately positioning the child to permit the child to easily access the toys.

### SUMMARY OF THE INVENTION

The invention provides kits and techniques for presenting items, such as toys, to infants or small children. In one embodiment, such a kit includes a pillow having a pillow body and at least one attachment mechanism that is connected to the pillow. The kit also includes at least one bar that may be positioned over the pillow, with the attachment mechanism being used to attach the pillow to the bar. In this way, the bar may remain positioned over the pillow when in use. The bar also includes at least one coupling mechanism to permit one or more toys to be coupled to the bar. In this manner, the toys may be suspended over the pillow to permit a child to lie on the pillow and to reach up and play with the toys.

In some embodiments, the kits may also include a mat that is placed onto a surface, with the pillow body resting on the mat. The bar may then be coupled to the pillow body and/or the mat. The mat may be either integrally attached to the pillow body or be removably attached to the pillow body.

In one aspect, the pillow has a medial region and two opposing arms that define a generally open well. Such a configuration permits a baby to be placed within the well, with the baby's head resting on the medial region. In this way, the medial region provides a comfortable support for the baby's head as well as “propping up” the baby so that the baby may easily reach the suspended toys. Further, the two arms prevent the baby from rolling from side to side so that the toys will remain suspended over the baby. When used with the mat, the baby's body may rest upon the mat. For example, the mat may be configured to extend across the well and beyond that opposing arms. In this way, the baby may lie within the well and rest on the mat, rather than directly on the floor.

The bar may include two or more ends that may be placed onto a surface onto which the pillow also rests to hold the bar over the pillow. The attachment mechanisms may be coupled to the bar at or just above the ends so that a middle section of the bar is free to suspend the toys. The bar may be fashioned into a variety of shapes. For example, the bar may be curved over the pillow. Further, multiple bars may be used to increase the number of toys that may be suspended. Merely by way of example, two bars may be used that each have a pair of ends. The four ends of the bars extend around the periphery of the pillow to help hold the pillow beneath the bars. For instance, two of the ends may be positioned near the free ends of the opposing arms while the other two ends are positioned near where the arms are joined to the medial region. However, it will be appreciated that other arrangements are possible particularly depending on the numbers of bars and/or ends of the bars.

A variety of attachment mechanisms may be used to attach the pillow to the bars. For example, a loop of fabric or other material that is coupled to the pillow body may be used. With such a configuration, the ends of the bars may simply be slid through the loops. Other attachment mechanisms include fabric or other strips having snaps, a hook and loop fastener material, such as Velcro, or the like. Alternatively, the strips may be tied together. In some cases, the attachment mechanism may be a pocket on the pillow or the mat into which the end of the bar is inserted.

In a similar manner, a variety of coupling mechanisms may be used to couple the toys to the bars. For example, the coupling mechanism may comprise a strip of fabric or other material hanging from the bar. The strip may include a snap or a hook and loop fastener material to permit the strip to be looped around the toy and fastened together.

Instead of providing a pillow with the kit, a pillow cover may alternatively be used. Optionally, a mat may be included that is integrally attached or removably attachable to the cover. In this way, a user already having a pillow may simply place the cover over the pillow and then attach the pillow to the bar. Conveniently, the attachment mechanisms may be coupled to the cover or the mat so that the pillow may easily be attached to the bar once the cover is placed over the pillow. The pillow cover may optionally include a zipper or other fastener to permit the cover to be opened when placing the cover about the pillow. Once in place, the zipper is closed to secure the cover about the pillow.

In use, a child may be placed onto the pillow so that the child is lying face up. The bar may be placed over the child and secured to the pillow. This may be done while the toys are attached to the bar, or afterward. Alternatively, the bar may be placed about the pillow, and the child inserted between the bar and the pillow. Once in place, the toys are suspended over the child's head and chest to permit the child to reach up and play with the toys. If desired, one ore more of the toys may be removed and substituted with another toy. Optionally, a mat may be positioned under the pillow so that at least a portion of the child may rest upon the mat.

### BRIEF DESCRIPTION OF THE DRAWINGS

FIG. 1 is a top view of an embodiment of a pillow according to the invention.

FIG. 2 is a front view of the pillow of FIG. 1.

FIG. 3 illustrates a kit having the pillow of FIG. 1 and a pair of bars that suspend a set of toys over the pillow according to the invention.

FIG. 4 is a side view of the kit of FIG. 3.

FIG. 5 illustrates a method for using the kit of FIG. 3.

FIG. 6 illustrates an alternative attachment mechanism for attaching a bar to a pillow according to the invention.

FIG. 7 illustrates an alternative kit for suspending toys over a pillow according to the invention.

FIG. 8 illustrates another alternative kit for suspending toys according to the invention.

### DESCRIPTION OF THE SPECIFIC EMBODIMENTS

The invention provides structures and techniques for suspending objects, such as toys, over infants or small children. Conveniently, the toys may be positioned within the grasp of the child while the child is lying down, inclined or sitting upright. To suspend the objects, the invention utilizes a suspension system or other type of structure from which one or more objects may be suspended. The suspension system or structure may have at least one end or a base that is configured to rest on a surface or to be mounted to another type of structure. For example, the ends may be mounted to a pillow or a mat disposed beneath the pillow. As another example, the ends of the suspension system may all rest a support surface, or one or more ends may be suspended in air. One way to construct the suspension system is by the use of one or more bars or poles that extend into the air so that objects may be suspended from the bars. The bars may be joined together, may cross each other, or be formed as an integral unit. The bars may be constructed of any material having sufficient rigidity to remain suspended in air. Merely by way of example, types of materials that may be used include metals, plastics, composites, wood, rubbers, and the like.

The bar structure may be configured to be positioned about a perimeter of a pillow or other resilient structure on which the child is to be placed. This arrangement permits the support structure to be appropriately positioned so that objects may be suspended over the pillow. Further, by surrounding the pillow, the support structure helps to prevent movement of the pillow relative to the suspended objects. Optionally, the bar structure may be toupled to the pillow to further prevent movement of the pillow relative to the bar structure.

The suspension system may be configured to suspend the objects at essentially any height relative to the child. For example, the objects ma be immediately above the child's head or chest to permit the child to reach up and grasp the objects. Alternatively, the objects may be placed out of reach of the child.

A wide variety of pillows may be used to support and/or to restrain movement of the child. For example, one type of pillow that may be used includes a medial region and two opposing arms that define an open well. Such pillows are described in, for example, U.S. Pat. Nos. 5,261,134; 5,546,620; 5,661,861; and 6,038,720. Other types of pillows that may be used to support the child are described in copending U.S. patent application Ser. No. 09/662,935, filed Sep. 15, 2000 (Attorney Docket No. 17242-007100) and ______, filed on the same date as the present application (Attorney Docket No. 17242-000225). The complete disclosures of all these references are herein incorporated by reference. Other types of pillows having other shapes and configurations that are known in the art may also be used. One advantage of a pillow having a medial region and two opposing arms is that the arms may be used to restrain the child to limit the child's movement. In this way, the objects may remain appropriately positioned over the child.

In some embodiments, the pillow may be coupled to a mat that is positioned beneath the pillow body. Such a mat may be constructed of a flexible material, such as a fabric. The mat may be integrally or removably coupled to the pillow body. In this way, the child may rest on the mat as well as the pillow body. One non-limiting example of such a mat is described in U.S. Pat. No. 5,546,620, previously incorporated by reference.

Conveniently, the suspension system and support pillows may be provided in kit form. In this way, a consumer may purchase a kit having both a pillow and a suspension system. Optionally, one or more objects that are to be suspended may also be provided with the kit. In one option, a kit may be provided having a suspension system and a cover, with or without a mat. In this way, a consumer already having a pillow may simply place the cover over the pillow. The cover may have one or more attachment mechanisms to permit the pillow to be attached to the suspension system. Non-limiting examples of covers that may be used are described in copending U.S. patent application Ser. No. ______, filed on the same date as the present application (attorney docket no. 17242-008400), the complete disclosure of which is herein incorporated by reference.

A variety of attachment mechanisms may be used to attach the pillows and/or mats to the suspension systems. For example, one or more fabric strips, strings or loops may extend from the pillow or mat. These may be placed, wrapped or tied around the bars of the suspension system. Conveniently, snaps, buckles, a hook and loop fasteners material, or the like may also be used in attaching the pillow to the bars. In some cases, the pillow or mat may include one or more pockets into which ends of the bars may be placed. The attachment mechanisms may be coupled to a cover of the pillow or integrally formed with the pillow body.

A wide variety of objects may be suspended over the child. For example, the objects may comprise toys that are education in design or that are configured to simply entertain or distract the child. For instance, such toys may include: balls, blocks, planes, space ships, vehicles, blocks, numbers, letters, animals, insects, figures and the like. Further, the objects may be constructed of various materials and maybe of different colors.

The objects may be coupled to the suspension system in a variety of ways. For example, coupling mechanisms such as fabric strips, strings, chains and the like may be used. The objects may have a hole, hook, or the like through which the coupling mechanism may be passed, looped or tied. Conveniently, snaps, buckles, hook and loop fastener materials, or the like may be used as coupling mechanisms. The length of the coupling mechanisms may be adjustable to vary the height at which the objects are suspended over the child. The coupling mechanism may even be elastic to permit the object to be grasped and pulled down to the child.

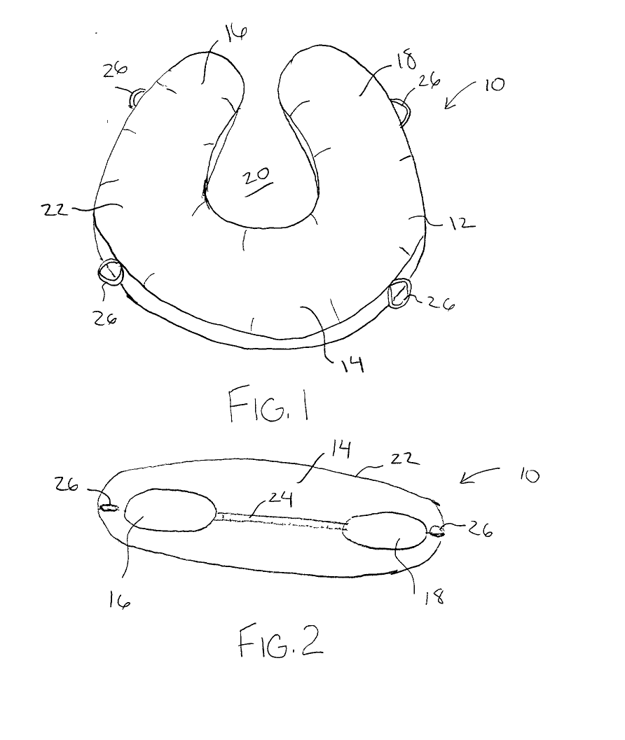

Referring now to FIG. 1, one embodiment of a support pillow 10 will be described. Pillow 10 is constructed of a pillow body 12 having a medial region 14 and two opposing arms 16 and 18 that define a generally open well 20. Pillow body 12 may be constructed in a manner similar to that described in U.S. Pat. Nos. 5,261,134; 5,546,620; 5,661,861 and 6,038,720, previously incorporated by reference. Pillow 10 conveniently includes a fabric cover 22. As best shown in FIG. 2, cover 22 includes a zipper 24 to permit cover 22 to be opened and closed. In this way, cover 22 may be placed over and removed from pillow body 12.

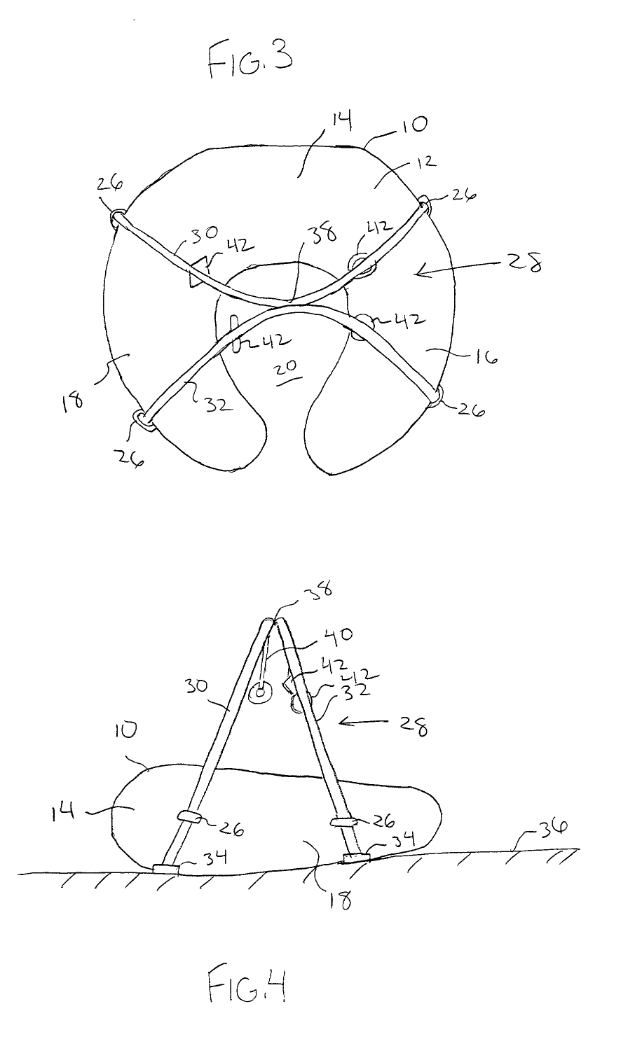

Sewn to seams of cover 22 are a set of fabric loops 26 that serve as attachment mechanisms for a suspension system 28 as shown in FIGS. 3 and 4. In this way, pillow 10 may be secured to suspension system 28 to prevent relative movement between suspension system 28 and pillow 10. Configuration of cover 22 is advantageous in that suspension system 28 and cover 22 may be sold as a kit so that consumers already having a support pillow need only purchase a cover rather than another pillow. Alternatively, pillow 10 may be constructed to have a non-removable cover having attachment mechanisms. In this way, a kit may be provided both with a suspension system and with a pillow.

Suspension system 28 comprises a pair of curved bars 30 and 32 having ends 34 that rest on a surface 36 along with pillow 10. Ends 34 may be shaped or oversized to help stabilize bars 30 and 32. Bars 30 and 32 are joined together at an apex 38 and are shaped such that loops 26 extend around bars 30 and 32 as shown. Bars 30 and 32 may be placed over pillow 10 and the ends inserted through loops 26. Alternatively, other attachments may be used that are looped or tied around the bars after the bars are in place. Bars 30 and 32 are positioned about pillow 10 so as to provide a large enough opening to place the child onto the pillow and to provide a generally open environment. Hanging from bars 30 and 32 are fabric strips 40. Conveniently, bars 30 and 32 may include holes through which strips 40 are fastened. Coupled to strips 40 are a set of toys 42, including a ball, a ring and a block. However, it will be appreciated that a variety of other objects may be suspended as previously described. Conveniently, strips 40 may include snaps to permit strips 40 to be wrapped around toys 42 and then snapped together. However, a variety of other coupling devices may be used as previously described. Although shown with four toys, it will be appreciated that any number of toys may be suspended. Further, these may be suspended at any height and at any location on bars 30 and 32.

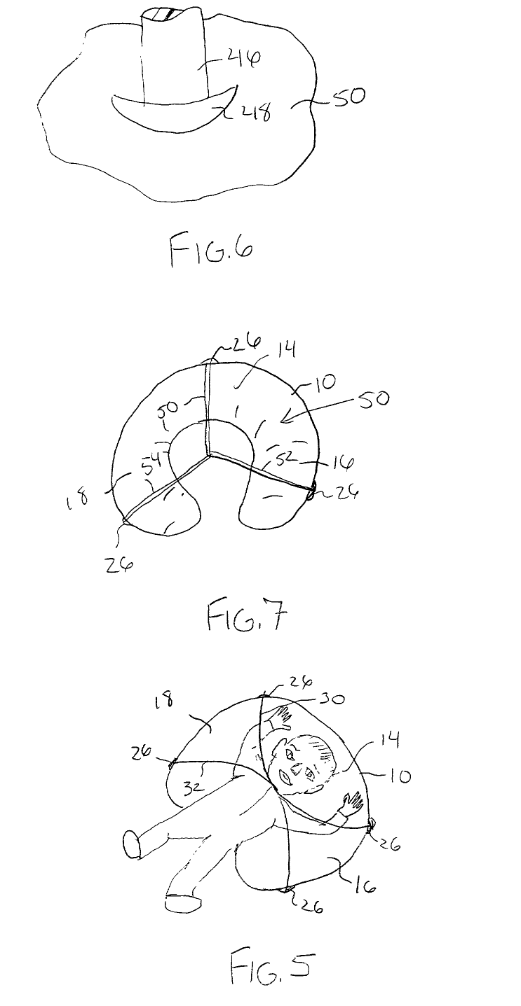

In use, a child may be placed onto pillow 10 as shown in FIG. 5. The child's head is positioned on top of medial region 14 while the torso is received within the open well. In this way, arms 16 and 18 prevent the child from rolling from side to side. At the same time, medial region 14 props the child's head to permit the child to easily see and grasp the toys. If desired, additional padding may be placed under the baby as described in the previously incorporated patent documents. In some cases, the child may be placed in a sitting position within the well, with the toys hanging in front of the child. Other orientations of the child and toys are also possible.

Instead of resting the suspension system directly onto a surface, the ends of the bars may be held by the pillow itself. An example of such a configuration is shown in FIG. 6 where a flexible pole 46 is held within a pocket 48 if a cover 50. A similar pocket maybe provided on an opposite side of cover 50, and pole 46 may be flexed and inserted into the pockets. The tension in pole 46 holds the pole in place within the pockets.

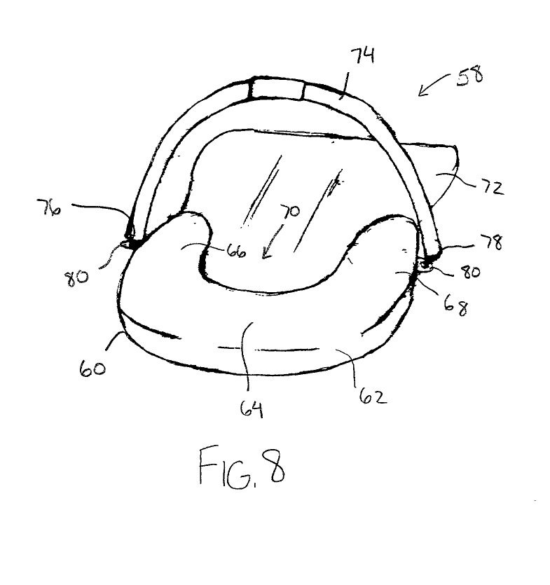

The suspension systems of the invention may include other number of bars and/or feet. One example of such a configuration is shown in FIG. 7. In FIG. 7, pillow 10 has been modified to include three loops 26. Used with pillow 10 is a suspension system 50 having three bars 50, 52 and 54 and three ends. One end is adjacent medial region 14 while the other ends are adjacent arms 16 and 18. In this way, an access way is provided to place the child onto pillow 10.

Any of the kits and/or suspension systems may be used with a mat that is positioned beneath the pillow body. One example of such a kit 58 is illustrated in FIG. 8. Kit 58 includes a support pillow 60 that comprises a pillow body 62 having a medial region 64 and two arms 66 and 68 extending from medial region 64. Arms 66 and 68 are generally parallel to each other and are spaced apart to from an open well 70. Disposed beneath pillow body 62 is a mat 72. Arms 66 and 68 are spaced apart to provide a relatively large well 70 so that a child will have additional space to play when resting upon mat 72. Alternatively, arms 66 and 68 could be spaced closer to each other to form a more circular well region.

Shown positioned above pillow 62 is a bar 74 having ends 76 and 78. Bar 74 is configured to be inserted through fabric loops 80 on arms 66 and 68 so that ends 76 and 78 rest upon a support surface, such as a floor. Conveniently, pillow body 62 may include a fabric cover into which loops 80 are coupled. Although shown with fabric loops, it will be appreciated that a wide variety of attachment mechanisms may be used to couple bar 74 to pillow 60, including any of those described with other embodiments. Further, in some cases, attachment mechanism may be provided on mat 72. For instance, mat 72 may include holes or pockets into which ends 76 and 78 are inserted.

Bar 72 may be employed to suspend one or more items above pillow body 62 and/or mat 72. Although not shown various coupling mechanism may be used to suspend these items in a manner similar to that described with other embodiments. Further, different numbers and/or configurations of bars may be used similar to those described with other embodiments.

Mat 72 may be fashioned in a variety of shapes and sizes. As shown, mat 72 extends across well 70 and horizontally beyond arms 66 and 68. In this way, a child may rest and play on pillow body 62 while the rest of the child's body rests on mat 72. Hence, mat 72 may be long enough so that when a child is resting on medial region 64 (or lying within well 70), the child's feet are still on mat 72. As shown, mat 72 has an hour glass shape. However, a variety of other shapes may be used, such as rectangular, scalloped, arcuate, and the like.

Mat 72 may be constructed of essentially any type of material suitable for use with small children, and may be rigid, flexible, padded and the like. For instance, mat 72 may be constructed of a sheet of fabric, which may optionally include padding.

Mat 72 may further be configured to be either integrally attached to pillow body 62 or removable. For example, mat 72 may be sewn to the pillow body 62. Alternatively, various fasteners may be used to removably attach mat 72 to pillow body 62. Such fasteners may include, for example, a hook and loop fastener material, snaps, buttons, and the like. In this way, mat 72 may be removed when desired. In some cases, pillow body 62 may include a removable cover. In this way, mat 72 may be removed from pillow body 62 along with the cover.

The invention has now been described in detail for purposes of clarity and understanding. However, it will be appreciated that certain changes and modifications may be practiced within the scope of the appended claims. For example, it will be appreciated that other variations of the suspension system are possible. For instance, only a single bar could be used. Further, one end of the bar may be suspended above the pillow.

What is claimed is:

1. A play kit comprising:
a pillow comprising a pillow body, a mat operably coupled to the pillow body and at least one attachment mechanism; and
at least one bar that is positionable over the pillow, with the attachment mechanism coupling the pillow to the bar.

2. A kit as in claim 1, wherein the bar has a pair of ends that are adapted to be placed onto a surface along with the pillow, and wherein the bar is curved so that a middle section of the bar is disposed above the pillow.

3. A kit as in claim 1, wherein the mat comprises a sheet of fabric that rests underneath the pillow body.

4. A kit as in claim 3, wherein the pillow body includes a medial region and a pair of opposing arms that form a generally open well, and wherein the mat extends across the open well and beyond the arms.

5. A kit as in claim 1, wherein the bar includes at least one coupling mechanism to permit a toy to be coupled to the bar and held above the pillow.

6. A kit as in claim 5, further comprises at least one toy coupled to the bar by the coupling mechanism.

7. A kit as in claim 5, wherein the coupling mechanism comprises a strip of material and a snapping device.

8. A kit as in claim 1, wherein the pillow further comprises a cover disposed about the pillow body, and wherein the attachment mechanism comprises a loop of material that is coupled to the cover.

9. A play kit comprising:
a pillow cover that is adapted to be placed about a pillow;
a mat that is adapted to be coupled to the pillow cover; and
at least one bar that is positionable over the pillow cover and the mat.

10. A kit as in claim 9, wherein the pillow cover includes a zipper to permit the pillow cover to be fastened about the pillow, and wherein the pillow cover or the mat includes at least one attachment mechanism to couple the bar to the pillow.

11. A kit as in claim 9, wherein the bar has a pair of ends that are adapted to be placed onto a surface along with the pillow, and wherein the bar is curved so that a middle section of the bar is disposed above the pillow cover.

12. A kit as in claim 9, wherein the mat comprises a sheet of fabric that is configured to be placed beneath the pillow cover.

13. A kit as in claim 12, wherein the pillow cover includes a medial region and two opposing arms that define a generally open well, and wherein the cover includes an open interior for receiving a pillow.

14. A kit as in claim 13, wherein the mat is configured to be positioned across the well and to extend beyond the arms.

15. A kit as in claim 9, wherein the bar includes at least one coupling mechanism, and at least one toy coupled to the bar by the coupling mechanism.

16. A kit as in claim 15, wherein the coupling mechanism comprises a strip of material and a snapping device.

17. A kit as in claim 10, wherein the attachment mechanism comprises a loop of material that is attached to the cover.

18. A play kit comprising:
a pillow comprising a pillow body having a medial region and a pair of opposing arms that define a generally open well, and a mat operably coupled to the pillow body; and
a suspension system that is configured to suspend at least one toy over the pillow.

19. A kit as in claim 18, wherein the suspension system comprises an arrangement of bars and at least one coupling mechanism hanging from the arrangement of bars.

20. A kit as in claim 19, wherein the suspension system further comprises a set of feet that are configured to rest on a surface.

21. A kit as in claim 20, wherein the mat comprises a fabric sheet that extends across the well and extends beyond the arms.

22. A method for presenting at least one toy, the method comprising:
placing a pillow onto a surface, the pillow comprising a pillow body having a medial region and a pair of opposing arms that define a generally open well, and a mat operably coupled to the pillow body, wherein the mat rests on the surface and the pillow body rests on the mat; and
attaching at least one bar to the pillow and coupling a toy to the bar such that the toy is suspended over the pillow.

23. A method as in claim 22, further comprising placing a child onto the pillow, with the child's head resting on the medial region and the child's torso resting on the mat.
